(19) United States
(12) Patent Application Publication
(10) Pub. No.: US 2002/0063689 A1
(43) Pub. Date: May 30, 2002

(54) Cordless computer keyboard

(76) Inventor: Gregory K. Rogers, The Colony, TX (US)

Correspondence Address: Stephen R. Greiner, Esquire, GREINER LAW OFFICES, P.C., 6701 Democracy Blvd., Suite 110, Bethesda, MD, 20817, US

(21) Appl. No.: 09/725,116

(22) Filed: Nov. 29, 2000

(51) Int. Cl. G09G 5/00

(52) U.S. Cl. 345/168

(57) ABSTRACT

A cordless computer keyboard including a platform portion supporting a keypad and a handle portion extending rearwardly from the platform portion. A rotatable trackball projects, in part, from the top of the handle portion. a movable trigger extends downwardly from the front of the handle portion. A leg extends downwardly from the platform portion and has a length sufficient to elevate the trigger above a planar supporting surface

### FIELD OF THE INVENTION

The present invention relates generally to electrical computers and data processing systems and, in particular, to specialized input devices therefor.

### BACKGROUND OF THE INVENTION

A personal computer includes a keyboard, a monitor, and a central processing unit. These items are typically arranged on a desktop and interconnected by cables for use. The cables take up space, make a poor visual impression, and limit the operability of the computer. Thus, attempts have been made to eliminate cables and replace such with optical signal transmission systems.

Cordless keyboards employing optical signal transmission systems have been proposed but have not seen widespread commercial acceptance. Perhaps this is because these keyboards have been clumsy in design and difficult to carry; or, perhaps this is because they cannot be easily perched on the lap of a user as easily as they can upon a tabletop. Whatever the reason, a need exists for a cordless keyboard that is easy to transport, set up, use and store.

### SUMMARY OF THE INVENTION

In light of the problems associated with the prior art, it is a principal object of the invention to provide a cordless keyboard that permits a user to comfortably operate a computer from a distance. The keyboard can be operated while being carried or positioned on the lap of a user or upon a table.

It is an object of the invention to provide improved elements and arrangements thereof in a cordless computer keyboard for the purposes described which is lightweight in construction, inexpensive to manufacture, and dependable in use.

Briefly, the cordless computer keyboard in accordance with this invention achieves the intended objects by featuring a platform portion having a keypad with a plurality of keys. A handle portion having a width narrower than that of the platform portion extends rearwardly from the platform portion. A rotatable trackball is positioned in the top of the handle portion and a movable trigger extends downwardly from the front of the handle portion. A leg extends downwardly from the platform portion and has a length sufficient to elevate the trigger above a planar supporting surface. Positioned within the keyboard are means for generating and broadcasting light signals representative of characters and commands in response to movements of the keys, the trackball, and the trigger.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a cordless keyboard in accordance with the present invention.

FIG. 2 is a bottom view of the cordless keyboard of FIG. 1 with portions broken away.

FIG. 3 is a side view of the cordless keyboard.

FIG. 4 is a front view of the cordless keyboard.

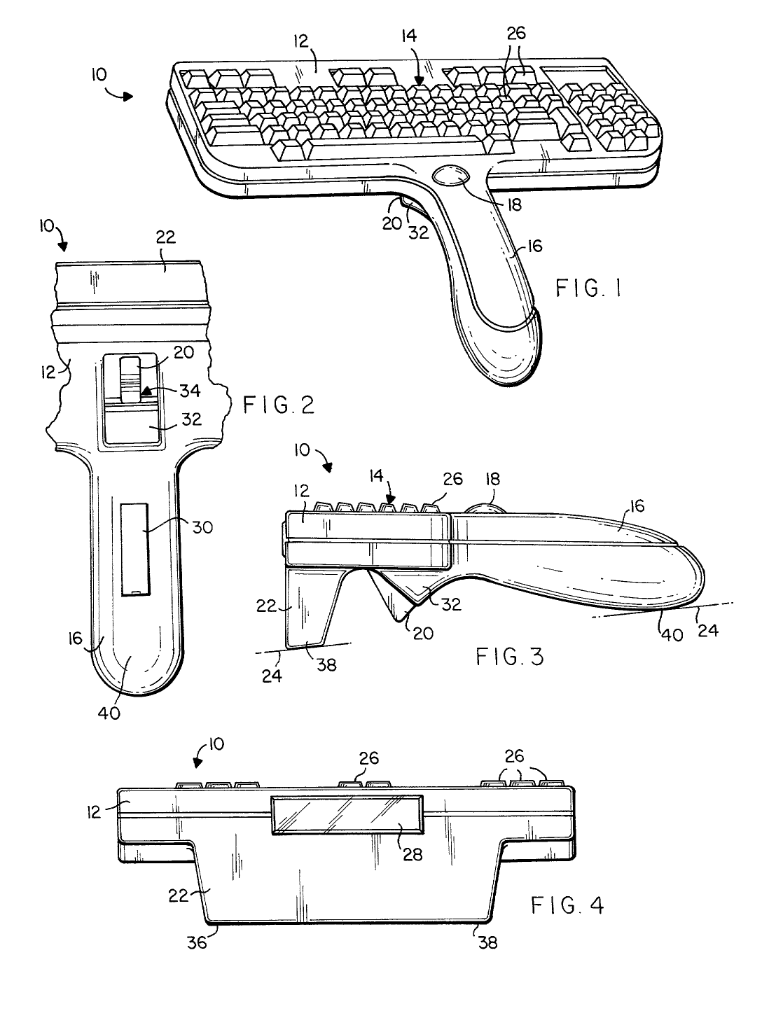

Similar reference characters denote corresponding features consistently throughout the accompanying drawings.

### DETAILED DESCRIPTION OF THE PREFERRED EMBODIMENT

Referring out to the FIGS., a cordless keyboard is seen at 10. Keyboard 10 includes an elongated platform portion 12 serving as a base for a keypad 14 and a handle portion 16 extending from the rear of platform portion 12. Atop handle portion 16, at its junction with platform portion 12, is a trackball 18. Projecting downwardly from a bottom of platform portion 12 are a movable trigger 20 and a leg 22 for elevating trigger 20 above a planar supporting surface 24 when keyboard 10 is placed thereon.

Platform portion 12 is preferably rectangular in outline and has a plurality of depressible keys as at 26 positioned about its top comprising keypad 14. When a key 26 is depressed, keyboard 10 transmits a unique character or command to a central processing unit (not shown) in a manner like that described in U.S. Pat. No. 5,081,628, issued to Hitoshi Mackawa et al on Jan. 14, 1992, and incorporated by reference for all purposes herein. In a similar manner, rotating trackball 18 or squeezing trigger 20 causes the transmission of the unique command by keyboard 10 to the central processing unit.

On the front of platform portion 12 is a transparent plate 28 through which light signals representative of data or instructions are transmitted in a cordless manner between keyboard 10 and a central processing unit. Preferably, light-emitting and light-receiving elements (not shown) are positioned directly behind plate 28 and within platform portion 12 and accomplish these tasks. By positioning plate 28 at the front of platform portion 12, transmissions can be easily made to the central processing unit by a user facing the central processing unit.

The functional features of trackball 18, being like those well known in the field, will not be described in detail herein. Suffice it to say, however, trackball 18 is a rotatable sphere capable of being manipulated by the thumb of a user. The rotation of trackball 18 functions, by means of the central processing unit, to move the cursor pointer upon a computer monitor (not shown).

Handle portion 18 has a pistol grip configuration and is sized to be grasped easily by the left or right hand of a user. Handle portion 18 also has a rounded shape so as to not become snagged on articles of clothing or other objects that it may make contact with. In the bottom of handle portion 18 is a removable door 30 through which batteries may be inserted into keyboard—to power such.

Forward of door 30, a fairing 32 projects downwardly from the bottom of platform portion 12 and forms an extension to handle portion 16. Fairing 32 has a triangular shape when viewed from the side and has an opening 34 in its front through which trigger 20 extends.

Trigger 20 is a movable part of a switch that, when pulled rearwardly by the light pressure of a user's finger, will enter a command into the central processing unit in the manner of a well-known mouse button. Although only one trigger 20 is shown in the FIGS., a pair of triggers could easily be positioned side-by-side in opening 34 in the manner of a shotgun to serve as the right and left buttons on a conventional computer mouse.

Leg 22 projects from the front of platform portion 12 and has a length sufficient to prevent trigger 20 from being inadvertently depressed when keyboard 10 is positioned on supporting surface 24. Leg 22 is elongated and has a right end 36 positioned adjacent one end of platform portion 12 and a left end 38 remote from right end 38 and positioned adjacent the other end of platform portion 12. Such a positioning of the ends of leg 38, permits the outer ends of platform portion 12 to be rested atop the thighs of a user for convenient laptop use of keyboard 10.

Because right end 36, left end 38 and distal end 40 of handle portion 16 are widely spaced from one another, keyboard 10 can be positioned on supporting surface 24 without fear that keyboard 10 will tip over. Thus, keyboard 10 can be used equally well in laptop or tabletop modes.

Use of keyboard 10 is straightforward. First, keyboard 10 is positioned with plate 28 oriented toward the central processing unit either by: positioning leg 22 and handle end 40 upon supporting surface 24, or grasping handle portion 16 to hold keyboard 10 above supporting surface 24, or resting the bottom of platform portion 12 on the user's thighs with handle portion 16 positioned therebetween. Then, in a normal manner, keys 26 are struck and trackball 18 and trigger 20 are moved to input, retrieve, and manipulate information from the central processing unit. Work can proceed essentially as long as keyboard 10 and central processing unit are pointed at one another and the user desires. The progress of the i manipulation of such information can be followed by viewing the computer monitor associated with the central processing unit. When keyboard 10 is no longer needed, it may be conveniently stored in a drawer or other dedicated space for reuse later.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

I claim:

1. A cordless keyboard, comprising:
a platform portion having a keypad;
a handle portion extending rearwardly from said platform portion;
a rotatable trackball projecting in part from the atop of said handle portion adjacent said platform portion; and,
a movable trigger extending downwardly from the front of said handle portion.

2. A cordless keyboard, comprising:
a platform portion having a keypad with a plurality of keys;
a handle portion having a width narrower than that of said platform portion and extending rearwardly from said platform portion;
a rotatable trackball in the top of said handle portion;
a movable trigger extending downwardly from the front of said handle portion;
a leg extending downwardly from said platform portion and having the length sufficient to elevate said trigger above a planar supporting surface; and,
means for generating and broadcasting light signals representative of characters and commands in response to movements of said keys, said trackball, and said trigger.

3. A cordless keyboard, comprising:
a platform portion having a keypad with a plurality of keys;
a handle portion having a width narrower than that of said platform portion and extending rearwardly from said platform portion;
a rotatable trackball for generating instructions for transmission to a central processing unit projecting in part from the top of said handle portion adjacent said platform portion;
a movable trigger for generating instructions for transmission to a central processing unit extending downwardly from the front of said handle portion;
a leg extending downwardly from said platform portion and having a length sufficient to elevate said trigger above a planar supporting surface; and,
means, in communication with said keys, said trackball, and said trigger, for generating and broadcasting light signals representative of characters and commands in response to movements of said keys, said trackball, and said trigger.
